(19) United States
(12) Patent Application Publication
(10) Pub. No.: US 2017/0083441 A1
(43) Pub. Date: Mar. 23, 2017

(54) REGION-BASED CACHE MANAGEMENT

(71) Applicant: QUALCOMM Incorporated, San Diego, CA (US)

(72) Inventors: Scott Wang-Yip Cheng, Foothill Ranch, CA (US); Raheel Khan, Tustin, CA (US); Warren Lew, Irvine, CA (US)

(21) Appl. No.: 15/080,439

(22) Filed: Mar. 24, 2016

Related U.S. Application Data
(60) Provisional application No. 62/222,730, filed on Sep. 23, 2015.

(51) Int. Cl. G06F 12/08

(52) U.S. Cl. CPC G06F 12/0815; G06F 12/0862; G06F 12/084; G06F 12/0811; G06F 2212/602; G06F 2212/621

(57) ABSTRACT

Apparatuses and techniques are disclosed herein that enable region-based cache management. In some aspects, a configuration for a region of cache memory is determined based on characteristics of information to be written to the cache memory. Based on the determined configuration, an address range of the cache memory is allocated to define the region within the cache memory. A cache policy is the applied to the allocated address range to control caching of the information written to the region of cache memory. By so doing, regions of cache memory and respective caching policies applied thereto can be optimized for a variety of information types or usages.

### RELATED APPLICATIONS

This application claims priority to U.S. Provisional Patent Application Ser. No. 62/222,730, filed Sep. 23, 2015, the disclosure of which is incorporated by reference herein in its entirety.

### BACKGROUND

Field of the Disclosure

This disclosure relates generally to memory management in electronic and computing devices and, more specifically, to management of a cache memory associated with a processor.

Description of Related Art

Many electronic devices include a modem that enables wireless communication of data. To communicate the data via a wireless medium, whether transmitting or receiving, modems perform a variety of computationally intensive signal processing functions, such as calculating Fourier transforms and log-likelihood ratios. The data associated with these signal processing functions (which often execute in a parallel or interdependent fashion) can be written to a cache memory of the modem for reuse by one or more of the functions.

To prevent data loss or corruption, the data in the cache memory is also cached (e.g., stored or written) to another memory of the modem. Conventionally, a cache memory is set to write the data through to the other memory or write the data back to the other memory before the contents of the cache memory are flushed. Caching the data of the modem with one of these cache schemes, however, is often inefficient because cache access associated with signal processing can be non-uniform and result in excessive or unnecessary caching activity.

### SUMMARY

In some aspects, a method for managing a cache memory of a processor determines a configuration for a region of the cache memory. Based on the determined configuration, an address range of the cache memory is allocated to define the region within the cache memory. The method then applies, based on the determined configuration, a cache policy to the allocated address range to control caching of information written to the region of cache memory.

In other aspects, an apparatus for processing signals comprises a processor configured to implement functions that facilitate the processing of the signals, a cache memory configured to store information associated with the processing of the signals, and a cache manager. The cache manager determines a configuration for a region of the cache memory into which information can be written. To define the region within the cache memory, the cache manager allocates an address range of the cache memory based on the determined configuration. The cache manager then applies, based on the determined configuration, a cache policy to the allocated address range to control caching of the information associated with the processing of the signals that is written to the region of cache memory.

In yet other aspects, an apparatus for processing signals comprises a processor configured to implement multiple functions that facilitate the processing of the signals and a cache memory configured to store information associated with the processing of the signals. The apparatus also comprises means for determining, based on which of the multiple functions the processor implements, a configuration for a region of the cache memory. Further, the apparatus comprises means for allocating, based on the determined configuration, an address range of the cache memory to define the region within the cache memory and means for applying, based on the determined configuration, a cache policy to the allocated address range to control caching of the information associated with the processing of the signal that is written to the region of cache memory.

### BRIEF DESCRIPTION OF DRAWINGS

The details of various aspects are set forth in the accompanying figures and the detailed description that follows. In the figures, the left-most digit of a reference number identifies the figure in which the reference number first appears. The use of the same reference numbers in different instances in the description or the figures indicates like elements.

FIG. 1 illustrates an example system in accordance with one or more aspects.

FIG. 2 illustrates an example software stack capable of managing functions of a modem device.

FIG. 3 illustrates an example method for implementing region-based cache management.

FIG. 4 illustrates example cache configurations in accordance with one or more aspects.

FIG. 5 illustrates an example method for configuring a region of cache memory via pre-fetch instructions.

FIG. 6 illustrates an example environment that includes a computing device and wireless network.

### DETAILED DESCRIPTION

Modems often include cache structures for storing data contents that will be used to complete future operations. Conventionally, each of the cache structures is statically configured for a respective modem function and with a single cache scheme. Because functions of the modem access the cache structures in a varied or non-uniform fashion, however, application of a single cache scheme provides little, if any, optimization of modem performance or power. Further, the cache structures may be sized to support worst-case data access scenarios, which results in inefficient cache layout. For example, a cache structure used for demodulation functions of different protocols is usually sized to support worst-case data access of a single protocol. While sufficient for that protocol, this results in a cache structure that is likely over-sized and under-utilized with respect to other protocols. Considering the numerous combinations of protocols and functions implemented by the modem, designing around these worst-case scenarios can consume considerable die space and increase layout complexity.

This disclosure describes aspects of region-based cache management. The techniques and apparatuses described herein enable the application of multiple cache policies to respective regions of a cache memory. Sizes or attributes of these regions can be managed dynamically, while access to other regions of the cache memory continues. In some aspects, a configuration for a region of cache memory is determined based on characteristics of information (e.g., data or instructions) to be written to the cache memory. To define the region within the cache memory, an address range of the memory is allocated based on the determined configuration. A cache policy to control data caching is then applied to the allocated address range effective to manage the caching of information written to the region of cache memory.

These and other aspects of region-based cache management are described below in the context of an example system, techniques, and environment. Any reference made with respect to the example system, environment, or elements thereof, is by way of example only and is not intended to limit any of the aspects described herein.

### Example System

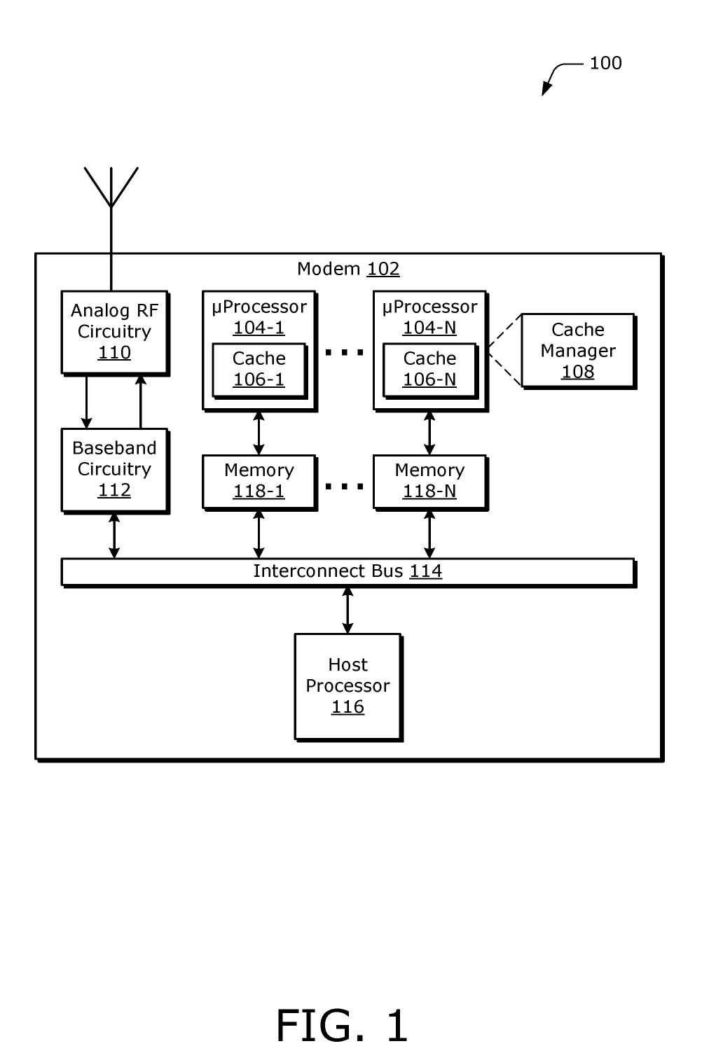

FIG. 1 illustrates an example system at 100, which is implemented as modem 102. Modem 102 can be configured to enable wireless or wired communication for any suitable host device. For example, modem 102 may be implemented in a smart phone, laptop computer, broadband modem, vehicle entertainment system, personal media device, and the like. In this particular example, modem 102 is configured as a multi-processor modem and includes μprocessors 104-1 through 104-N, which may be configured as single core or multicore μprocessors. Microprocessors 104-1 through 104-N can execute or manipulate information, such as instructions or data, to implement various functions of modem 118.

Each of μprocessors 104-1 through 104-N includes a respective one of cache 106-1 through cache 106-N, to which information of a respective μprocessor can be stored for reuse. Caches 106-1 through 106-N may be configured as any suitable type of memory, such as random-access-memory (RAM), static RAM (SRAM), and the like. In the context of this disclosure, caches 106-1 through 106-N are implemented as storage media or storage devices for data, and thus do not include transitory propagating signals or carrier waves In some aspects, cache 106-1 through cache 106-N are managed by cache manager 108, which is capable of allocating and configuring regions of each cache. Although shown associated with μprocessor 104-N, cache manager 108 can be implemented by any μprocessor of modem 102 and/or as multiple instances implemented by respective μprocessors. How cache manager 108 is implemented and used varies, and is described in greater detail below.

Modem 102 also includes analog RF circuitry 110, baseband circuitry 112, and interconnect bus 114. Interconnect bus 114, which may be configured as an advanced extensible interface (AXI) or advanced microcontroller bus architecture (AMBA) bus, enables communication between baseband circuitry 112, μprocessors 104-1 through 104-N, host processor 116, and/or memories 118-1 through 118-N.

Modem 102, or components thereof, may be implemented on multiple chips, multiple die, or a single chip that includes one or more die. In some cases, analog RF circuitry 110 is implemented on one chip, and baseband circuitry 112, μprocessors 104-1 through 104-N, memories 118-1 through 118-N, and interconnect bus 114 are implemented on another chip (e.g., system-on-chip). Cache manager 108 and other components of modem 102 may be implemented as hardware, fixed-logic circuitry, firmware, or a combination thereof that is implemented in association with signal or data processing circuitry of modem 102.

Analog RF circuitry 110 receives input data (data flows not shown for visual brevity) from a communication link or baseband circuitry 112. Analog RF circuitry 110 may translate received RF data to baseband data (or near baseband data) or translate baseband data to RF data for transmission via an antenna. Alternately or additionally, analog RF circuitry 110 may also perform filtering, gain control, DC removal, and other signal compensations.

Baseband circuitry 112 is configured to implement baseband processing, the functions of which may be performed using hardware or dedicated logic gates. Generally, baseband circuitry 112 is capable of implementing some modem functions more efficiently than a processor, such as high sample-rate processes that exceed a processing throughput of many programmable processors or digital-signal processors (DSPs). Some of the processes implemented by baseband circuitry 112 include gain correction, skew correction, frequency translation, and the like.

Microprocessors 104-1 through 104-N are configurable to execute various code to implement functions of modem 102, such as signal processing functions. Microprocessors 104-1 through 104-N may include any suitable number of processors, where N is any suitable integer. Alternately or additionally, μprocessors 104-1 through 104-N can be configured as scalar processors, vector processors, or a combination thereof. In this particular example, each of μprocessors 104-1 through 104-N is coupled with a respective one of memories 118-1 through 118-N.

Memories 118-1 through 118-N may be implemented using any suitable type of memory, such as SRAM, dynamic random-access memory (DRAM), double-data rate DRAM (DDR), and the like. In some aspects, memories 118-1 through 118-N are implemented as level two (L2) cache for each respective processor. In the context of this disclosure, memories 118-1 through 118-N are implemented as storage media or storage devices for data, and thus do not include transitory propagating signals or carrier waves.

In some aspects, μprocessors 104-1 through 104-N communicate data with others of μprocessors 104-1 through 104-N, host processor 116, or baseband circuitry 112 via interconnect bus 114. Each of μprocessors 104-1 through 104-N can be configured to execute code to implement one or more modulation or demodulation functions of the modem, such as frequency translation, encoding, decoding, in-phase and quadrature-phase (IQ) sample processing, log-likelihood ratios (LLR) calculation, discrete Fourier transform (DFT), fast-Fourier transforms (FFT), inverse-FFT (IFFT) transforms, hybrid-automatic repeat request (HARQ) operations, and the like.

Memories 118-1 through 118-N may also store code or instructions executed by μprocessors 104-1 through 104-N to implement the functions of modem 102. In some cases, execution of the code or instructions enables a processor to implement two or more functions of modem 102. Alternately or additionally, the code can be stored to a program memory (e.g., static RAM) of modem 102, within μprocessors 104-1 through 104-N, or an external memory coupled with modem 102.

Data associated with the functions implemented by μprocessors 104-1 through 104-N can be cached in a respective one of cache 106-1 through cache 106-N for reuse. In some cases, data associated with multiple functions is cached in one of cache 106-1 through cache 106-N that is configured as a shared cache. In such cases, a region of the shared cache can be configured for each of the multiple functions implemented by one of the μprocessors.

The data written to one of cache 106-1 through cache 106-N may be reused by a same function or by a different function implemented by a respective one of μprocessors 104-1 through 104-N. For example, a different function may access the data provided by a previously executed function, such as an intermediate data result for processing signal. In some aspects, cache manager 108 dynamically configures one or more of cache 106-1 through cache 106-N based on characteristics of data to be written to the cache or based on a particular type of function (e.g., signal processing function) that will access the data. Configuring the caches may include allocating address ranges to define regions within a cache or assigning a caching policy to a region of cache.

Modem 102 may also include host processor 116, which is coupled to other components of modem 102 via bus 114. In some cases, host processor 116 is configured to provide media functions and may be configured as a coder-decoder (CODEC) device, video processor, audio processor, of a combination thereof. Alternately or additionally, host processor 116 provides command and control signals for managing operations of other components of modem 102, such as analog RF circuitry 110, baseband circuitry 112, or μprocessors 104-1 through 104-N.

In some aspects, addresses are assigned to the components of modem 102 such that each component is addressable or accessible via interconnect bus 114. For example, μprocessor 104-1 may access data of memory 118-1, other memories coupled with interconnect bus 114, or external memories of modem 102. This addressing enables the distribution of the functions or operations among the various components of modem 102, such as baseband circuitry 112 and μprocessors 104-1 through 104-N.

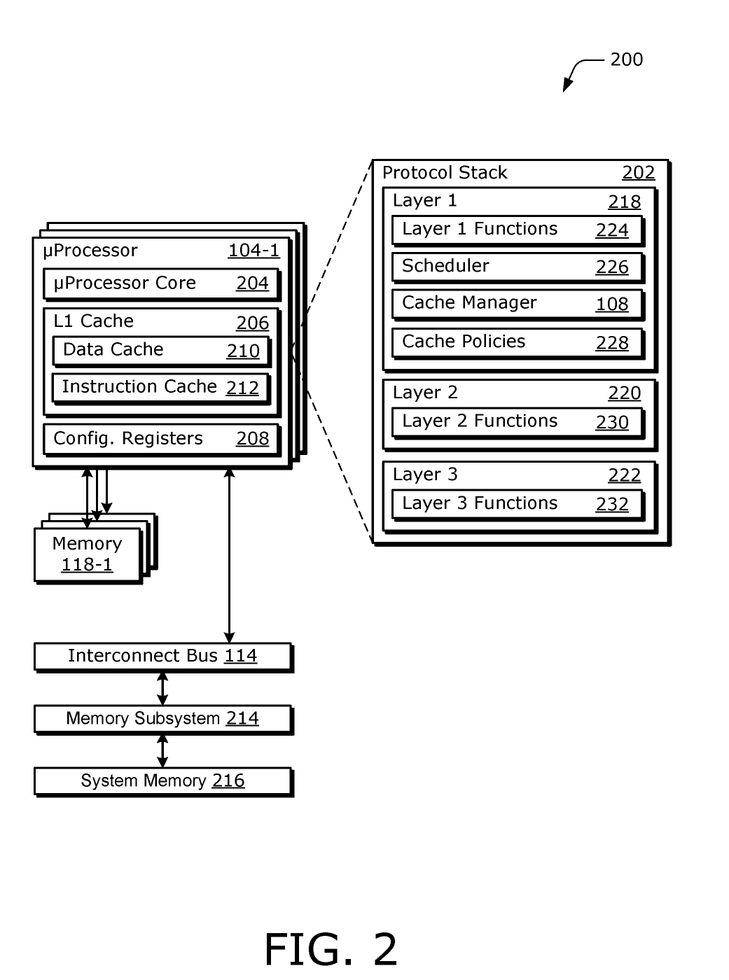

FIG. 2 illustrates an example software stack that is capable of managing functions of a modem generally at 200. In this particular example, protocol stack 202 is implemented with reference to μprocessors 104-1 through 104-N of modem 102 of FIG. 1. Any or all of μprocessors 104-1 through 104-N may be configured similar to, or differently than, μprocessor 104-1, which includes μprocessor core 204, level one (L1) cache 206, and configuration registers 208. For example, μprocessors 104-1 through 104-N may include multiple processor cores, multiple caches, tightly coupled memories, snoop control units, interrupt controllers, or various combinations thereof.

Generally, μprocessor core 204 executes processor-executable instructions to implement functions of modem 102. These instructions or other data associated with μprocessor core 204 are stored to L1 cache 206, which can be implemented similarly to cache 106-1 of FIG. 1. In this particular example, L1 cache 206 includes data cache 210 and instruction cache 212. Alternately, L1 cache 206 can be implemented as a combined cache structure for both data and instructions. Further, a processor may include multiple L1 cache structures or shared L1 cache structures that are accessible by multiple functions or elements of the processor.

L1 cache 206, or other caches of μprocessors 104-1 through 104-N, may be accessed via an address range or address space. In some cases, L1 cache 206 may be partitioned into regions by selecting or allocating particular address ranges of an address space of the cache, such as one or more address ranges that are less than an entire address space of the cache. Alternately or additionally, attributes of L1 cache 206 or regions thereof, can be configured via configuration registers 208, the values of which can be initialized or dynamically set. For example, information of configuration registers 208 may indicate or manage address ranges of particular cache regions and a respective cache policy applied to each of the regions.

When μprocessor core 204 implements one or more functions of modem 102, information associated with the functions can be cached to L1 cache 206 of μprocessor 104-1. In some cases, data or instructions stored in L1 cache 206 are retrieved by μprocessor core 204 from other memory locations, such as memory 118-1 (e.g. L2 cache) or memory subsystem 214, through which system memory 216 (e.g., DRAM) is accessible. Caching the data or instructions that will be reused by μprocessor core 204 to L1 cache 206 can improve processor performance and reduce latency by minimizing access to other memories.

Protocol stack 202 manages communications of modem 102 and provides an interface for data, voice, messaging, and other applications. In some cases, protocol stack 202 is implemented by executing a real-time operating system (RTOS) on one or more of μprocessors 104-1 through 104-N. Protocol stack 202 may be divided into a number of components or layers that correspond to respective networking or functional layers, such as those of the Open Systems Interconnection (OSI) model.

In this example, protocol stack 202 implements three layers to manage communications of modem 102, such as layer 1 218, layer 2 220, and layer 3 222. Each of these layers may be configurable to manage a respective networking layer of one or more communication protocols. The implementation of each layer may vary, with the functions of a respective layer being combinable or separable, within the layer or other layers, to support various configurations of modem 102 or protocol stack 202.

In some aspects, layer 1 218 corresponds to a physical layer and implements layer 1 functions 224 that may include signal processing functions (e.g., baseband functions). In this particular example, layer 1 218 also implements scheduler 226 to schedule execution of the modem's functions and an instance of cache manager 108. Layer 1 218 also includes cache polices 228, which can be applied to regions L1 cache 206 by cache manager 108.

Layer 2 220 corresponds to a link layer and implements layer 2 functions 230 for managing communication links of layer 1 218. Although not shown, layer 2 220 may include a media access control (MAC) sublayer, radio link control (RLC) sublayer, and a packet data convergence protocol (PDCP) sublayer. Layer 3 222 corresponds to a network layer and implements layer 3 functions 232 to manage control plane signaling of network connections. Layer 3 222 may also include a radio resource control (RRC) sublayer for managing resources of modem 102 associated with network layer activities.

Execution of each layer's functions can be coordinated or scheduled based on a mode or protocol being implemented by modem 102. With reference to layer 1 218, scheduler 226 can schedule one or more layer 1 functions 224 based on which protocol modem 102 is implementing. For example, when modem 102 switches from a 3G protocol to a 4G LTE protocol, scheduler 226 selects and schedules a set of functions for execution to provide appropriate signal processing operations, such as processing IQ samples, calculating LLRs, performing DFTs, modulation, demodulation, and so on.

When a function is executed by μprocessor core 204, instructions or data associated with the function can be written to L1 cache 206 or memory 118-1 (e.g., L2 cache) for future access. In some cases, the data of a function has particular characteristics with respect to cache access or causes a particular access pattern within L1 cache 206 or memory 118-1. These characteristics may include data volume, transaction sizes, types of data usage, locality of the data, access bandwidth, and the like. The data access characteristics or data access patterns associated with a function may be predetermined or known by entities of protocol stack 202, such as scheduler 226. Alternately or additionally, each of layer 1 functions 224, or any other set of functions, may have a different respective data characteristics or data access patterns associated therewith.

Cache manager 108 may configure L1 cache 206 based on characteristics of data to be written to the cache or a data access pattern of a function that will access the cache. To do so, cache manager 108 may determine a configuration for a region of L1 cache 206, such as a size, address range, location, cache policy, and the like. Based on the determined configuration, cache manager 108 can allocate the region of L1 cache 206 and apply one of cache policies 228 to the region. Cache policies 228 may include any suitable type of cache policy or scheme, such as a write-through policy, write-back policy, or read-only policy. In some cases, an instruction includes one or more bits configured to indicate an address range of a cache region or attributes of the cache region, such as a cache policy. In such cases, the instruction may be a pre-fetch instruction used to pre-fetch data or other instructions of a function.

The use of each type of cache policy may correspond with a type of data access (e.g., data access pattern) associated with different respective functions. For example, cache manager 108 may select a write-though cache policy for a function that provides data to another function to maintain cache coherency with system memory 216. In other cases, cache manager 108 may select a write-back policy for a function that operates orthogonal from other functions to store data to system memory 216 before lines of L1 cache 206 are flushed. In yet other cases, cache manager 108 can select a read-only policy to configure a region of L1 cache 206 as a scratch pad for fetching a combination of potential instructions and data for a function. Within the scratch pad, the data and instructions can be manipulated without caching and without causing the final results to be written out to system memory 216. These and other implementations of cache manager 108 may vary and are described in greater detail below.

### Techniques of Region-Based Cache Management

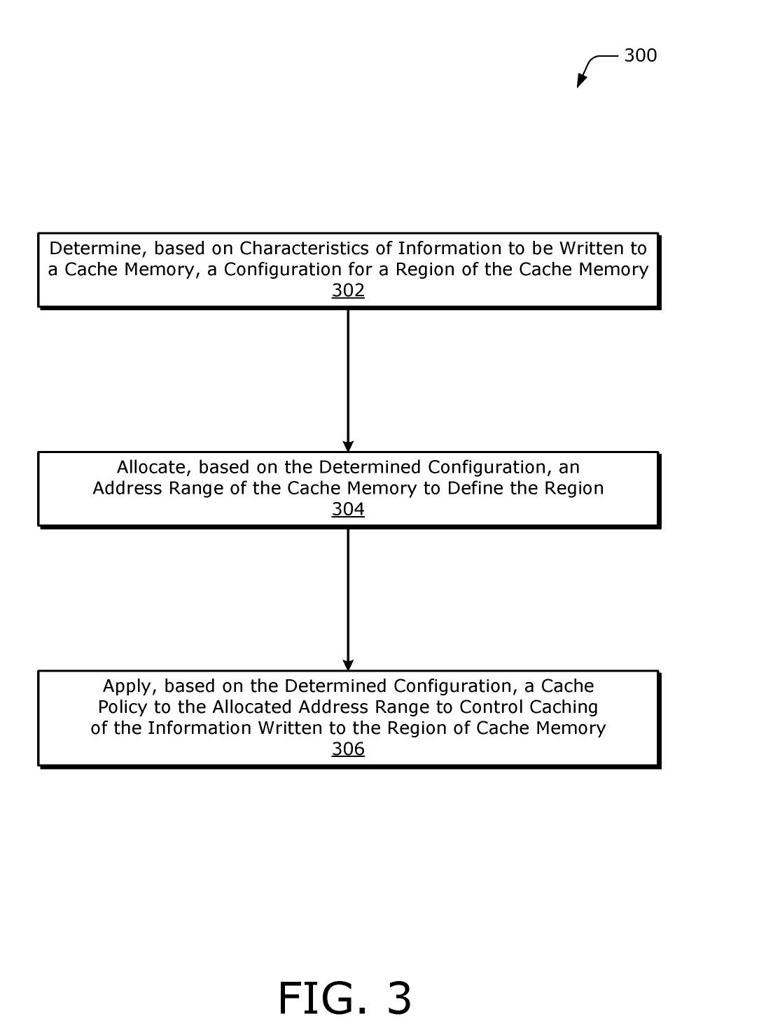

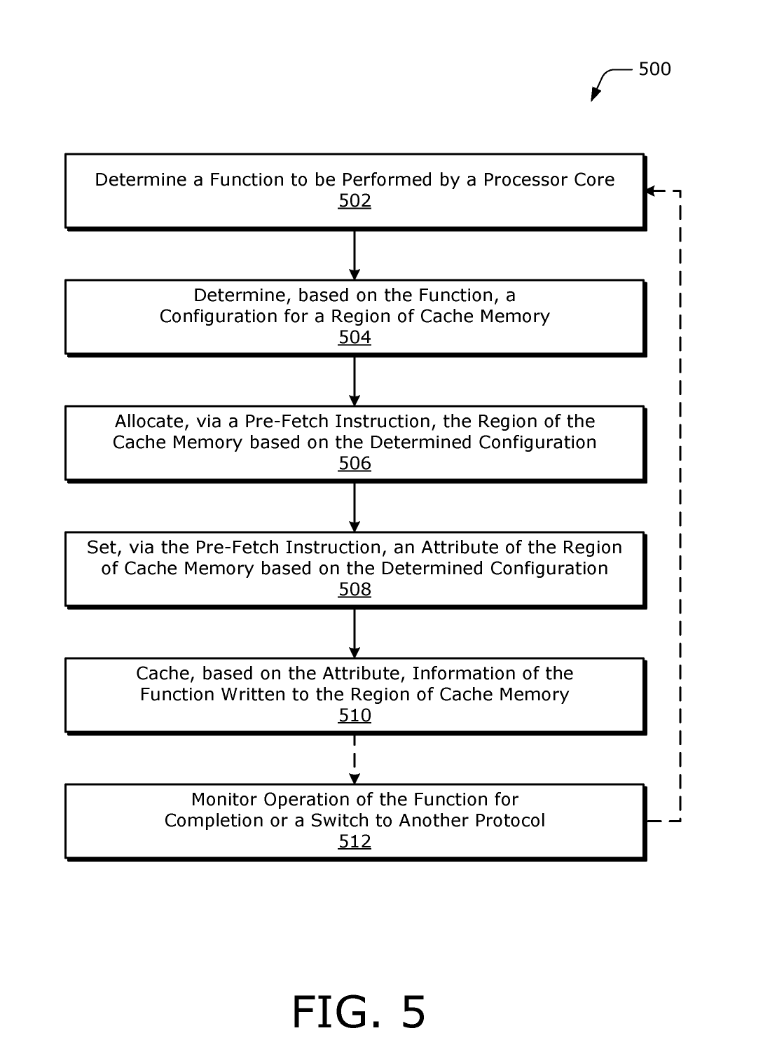

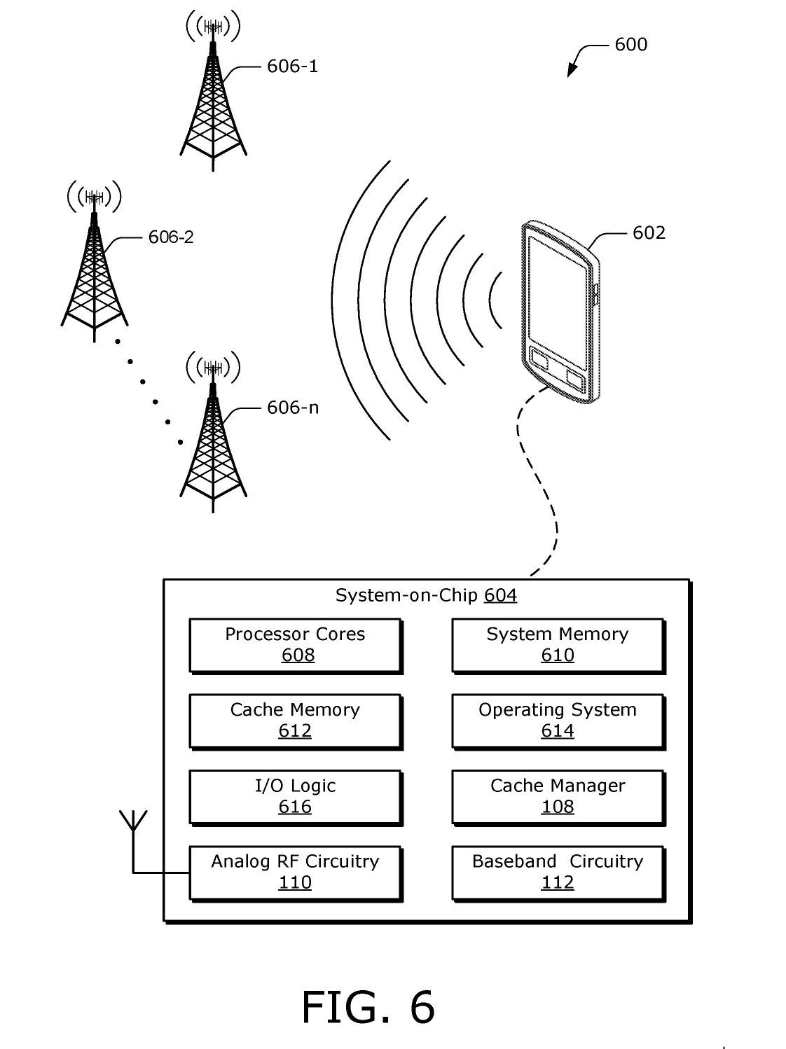

The following techniques of region-based cache management may be implemented using any of the previously described entities of the example system or environment 600 described with reference to FIG. 6. Reference to entities, such as modem 102, scheduler 226, or cache manager 108, is made by example only and is not intended to limit the ways in which the techniques can be implemented. The techniques are described with reference to example methods illustrated in FIGS. 3 and 5, which are depicted as respective sets of operations or acts that may be performed by entities described herein. The depicted sets of operations illustrate a few of the many ways in which the techniques may be implemented. As such, operations of a method may be repeated, combined, separated, omitted, performed in alternate orders, performed concurrently, or used in conjunction with another method or operations thereof.

FIG. 3 illustrates an example method 300 of region-based cache management, including operations performed by cache manager 108. In the following discussion, cache manager 108 or other entities of example system 100 may provide means for implementing one or more of the operations described.

At 302, the method includes determining, based on characteristics of data to be written to the cache memory, a configuration for a region of the cache memory of the processor. The cache memory may include an L1 or L2 cache memory associated with a processor of a modem. In some cases, the characteristics of the information to be written include a type of usage, locality of the information, or access bandwidth, any of which may be known or estimated before the information is written to the cache. The determined configuration may include a size of the region, a cache policy to apply to the region, or a location for the region within the cache memory.

The information to be written to the cache may be associated with a particular function or algorithm that accesses, or will access, the cache memory. As such, the configuration may be determined based on the function, a type of the function, or a known information access pattern associated with the function. For example, the configuration can be determined based on an indication of which function of multiple functions will execute. This indication can be received from a scheduling entity that schedules or knows an order in which the functions will execute. Previously-monitored information access patterns of the function may also be considered when determining the configuration of the region of cache memory.

At 304, the method comprises allocating, based on the determined configuration, an address range of the cache memory to define the region within the cache memory. The address range may specify a size or a location of the region within the address space of the cache memory. In some cases, multiple address ranges are allocated within the cache memory to define multiple respective regions. In other cases, a start or an end of an address range may be defined with reference to a boundary of an existing region. Alternately or additionally, the allocation of address ranges can be tracked or managed using a data structure or registers associated with the cache memory.

At 306, the method includes applying, based on the determined configuration, a cache policy to the allocated address range of the cache memory. This can be effective to control caching of the information written to the region of cache memory. In some cases, multiple cache policies are applied to multiple respective regions of the cache memory or a shared cache memory. In such cases, the cache may be implemented as a multi-policy cache for multiple functions. By so doing, a single or shared cache can support multiple caching policies to provide optimized caching for a variety of functions with different information access patterns.

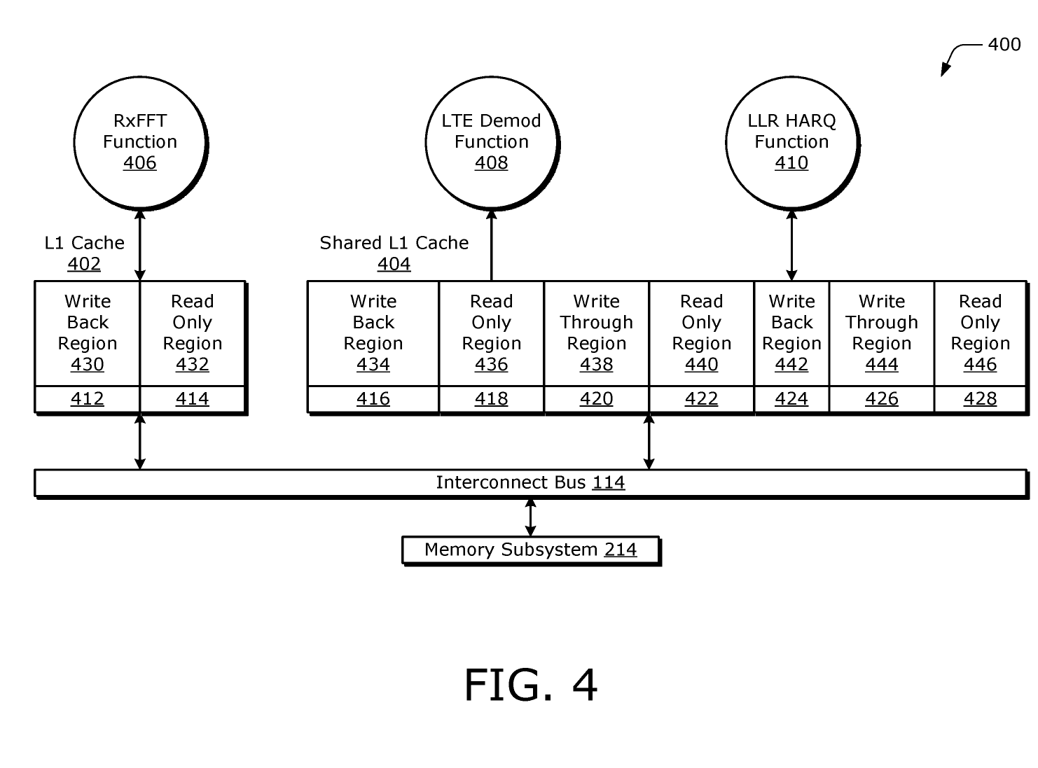

As an example of method 300, consider FIG. 4, which illustrates cache configurations in accordance with one or more aspects generally at 400. FIG. 4 includes two L1 caches, L1 cache 402 and shared L1 cache 404, which is configured for access by multiple functions. With reference to the entities of system 100, assume that, responsive to a protocol switch, scheduler 226 schedules receive FFT function 406 (RxFFT function 406), LTE demod function 408, and LLR HARQ function 410 for execution on μprocessor 104-1. Scheduler 226 then indicates the scheduling of these functions to cache manager 108.

In the context of operation 302, cache manager 108 then determines, based on the indication provided by scheduler 226, respective configurations for regions of cache memory that will be accessed by RxFFT function 406, LTE demod function 408, and LLR HARQ function 410. Specifically, cache manager 108 determines respective address ranges (e.g., size or location) and caching policies for regions of L1 cache 402 based on a data access pattern of RxFFT function 406. Cache manager 108 also determines respective address ranges and caching policies for regions of shared L1 cache 404 based on respective data access patterns associated with LTE demod function 408 and LLR HARQ function 410.

Continuing the example and in the context of operation 304, cache manager 108 allocates address range 412 and address range 414 of L1 cache 402 based on the determined configuration for RxFFT function 406. Cache manager 108 also allocates address range 416 through address range 428 of shared L1 cache 404 based on the determined configurations for LTE demod function 408 and LLR HARQ function 410. In some aspects, cache manager 108 allocates the address ranges through pre-fetch instructions that load instructions or data for a function. For example, cache manager 108 may configure bits or an address field of a pre-fetch instruction with a byte size or an address range to allocate a region of cache memory. This configuration can be set by accessing configuration registers 208.

Concluding the example and in the context of operation 306, cache manager 108 applies a write-back cache policy to address range 412 of L1 cache 402 to provide write-back region 430 and a read-only cache policy to address range 414 of L1 cache 402 to provide read-only region 432. Data or instructions of RxFFT function 406 are then fetched from memory subsystem 214 via interconnect bus 114 and loaded into write-back region 430 or read-only region 432. Cache manager 108 then, in similar fashion, applies various cache policies to address range 416 through address range 428 of shared L1 cache 404 to provide write-back region 434, read-only region 436, write-through region 438, read-only region 440, write-back region 442, write-through region 444, and read-only region 446.

Cache manager 108 may apply the cache policy through pre-fetch instructions that load instructions or data for a function to the respective regions. For example, cache manager 108 may configure bits of a pre-fetch instruction to apply or set particular attributes of the cache region, such as the cache policy or scheme. In some cases, execution of the pre-fetch instruction sets the attributes for the cache memory by accessing configuration registers 208.

FIG. 5 illustrates an example method for configuring a region of cache memory via pre-fetch instructions, including operations performed by cache manager 108. In some aspects, the operations of method 500 may be performed to implement an operation of method 300, such as to allocate an address range or apply a cache policy. In the following discussion, cache manager 108 or other entities of example system 100 may provide means for implementing one or more of the operations described.

At 502, the method includes determining a function to be performed by a processor core. In some cases, an indication is received from a scheduling entity that orchestrates or schedules execution of the function and other functions. The function may be a baseband or signal processing function that transmits data, receives data, performs iterative calculations, works orthogonal to other functions, works with other functions, and so on.

At 504, the method comprises determining, based on the function, a configuration for a region of cache memory. In some cases, the configuration for the region is determined based on a data access pattern associated with the function. The data access pattern may relate to the function's manipulations of data in the cache memory, such as a type of usage, locality of the data, or access bandwidth consumed by the function. The configuration can be selected from a set of pre-determined configurations that correspond to a set of functions, respectively. For example, cache manager 108 may select, responsive to an indication of a type of function to be executed, a pre-determined configuration from a set of pre-determined configurations. The determined configuration or pre-determined configuration may include a size of the region, a cache policy to apply to the region, or a location for one or more regions within the cache memory.

At 506, the method includes allocating, via a pre-fetch instruction, the region of the cache memory based on the determined configuration. The pre-fetch instruction can be configured to fetch data or instructions of the function from a main memory or system memory. The pre-fetch instruction can specify a size or a location of the region within the address space of the cache memory, such as by offset, address, address range, or combination thereof. The pre-fetch instruction, either independently or in combination with other instructions, may also allocate multiple regions of the cache memory. The allocation of the region can be tracked or managed using a data structure or registers associated with the cache memory.

At 508, the method comprises setting, via the pre-fetch instruction, an attribute of the region of cache memory based on the determined configuration. The attribute of the cache region may include a cache scheme, cache policy, cache interval, cache expiration, and the like. The pre-fetch instruction may include reserved bits or control a field in which the settings of the attributes are conveyed to a memory controller or control registers. The pre-fetch instruction that allocates the region of cache memory may be separate from the pre-fetch instruction that sets the attribute of the region. For example, a string of pre-fetch instructions can be issued to fetch data and instructions of the function, allocate multiple regions of a single cache or shared cache, and set respective attributes of each of the multiple regions.

At 510, the method includes caching, based on the set attribute, data of the function written to the region of cache memory. During performance or execution of the function, data of the region of cache memory is cached based on the set attribute. For example, when the attribute is a cache policy set for write-through, the function's data written to the cache is written through to main memory to maintain cache coherency of that region. Alternately, when the attribute is a cache policy set for write-back, the function's data written to the cache is written to main memory before flushing to reduce traffic and power consumption. Other settings of the region's attribute may enable manipulation of data in the region without caching, such as when the region is configured as a scratch pad for operations.

At 512, the method optionally comprises monitoring operation of the function for completion or a switch to another protocol. For example, operation 512 may be omitted if a protocol switch does not occur. In which case, an initial configuration of the cache (e.g., default) may persist until the modem resets or power cycles. The operation of the function or protocol switch may be monitored by a scheduling entity or other resource manager. In some cases, the region of cache memory can be released or freed in response to completion of the function or a protocol switch. From operation 512, the method may return to operation 502 to configure another region of the cache memory for another function that will be executed subsequently to, or in parallel with, the function.

### Example Environment

FIG. 6 illustrates an example environment 600 that includes computing device 602, which in this example is implemented as a smart-phone. Although illustrated as a smart-phone, this is for exemplary purposes only, and computing device 602 may be implemented as any suitable computing or electronic device, such as a laptop computer, a desktop computer, a server, cellular modem, personal navigation device, gaming device, vehicle navigation system, set-top box, and the like. Computing device 602 may include any suitable components, such as processors, memories (storing an operating system and applications), a display, input devices, communication modules, and the like. In this particular example, computing device 602 includes system-on-chip 604, which can be configured to enable communication with cell towers 606-1, 606, and/or 606-n. Although shown as three cell towers, cell towers 606-1 through 606-n may represent any suitable number of cell towers, where n equals any suitable integer.

Cell towers 606-1 through 606-n may communicate with computing device 602 by transferring a communication link between computing device 602 and cell towers 606-1 through 606-n, from one of the cell towers to another, commonly referred to as “handoff” of the communication link. In some aspects, any or all of cell towers 606-1 through 606-n may be implemented as another device, such as a satellite, cable television head-end, terrestrial television broadcast tower, access point, peer-to-peer device, mesh network node, fiber optic line, and the like. Therefore, computing device 602 may communicate with cell towers 606-1 through 606-n, or another device, via a wired connection, wireless connection, or a combination thereof.

System-on-chip 604 provides connectivity to respective networks and other electronic devices connected therewith. System-on-chip 604 may be configured to enable wired communication, such as Ethernet or fiber optic interfaces for communicating over a local network, intranet, or the Internet. Alternately or additionally, system-on-chip 604 may be configured to enable communication over wireless networks, such as wireless LANs, peer-to-peer (P2P), cellular networks, and/or wireless personal-area-networks (WPANs).

In some aspects, system-on-chip 604 enables computing device 602 to communicate with cell towers 606-1 through 606-n. The communications between computing device 602 and cell towers 606-1 through 606-n may be bi-directional or unidirectional. To facilitate communication with cell towers 606-1 through 606-n, system-on-chip 604 may perform frequency translation, encoding, decoding, modulation, and/or demodulation to recover data sent over a communication link between computing device 602 and cell towers 606-1 through 606-n.

The frequency translation may be an up-conversion or down-conversion, performed in a single conversion, or through a plurality of conversion steps. For example, translation from a radio frequency (RF) signal to a baseband signal may include a translation to an intermediate frequency (IF). In some cases, frequency translation, encoding, decoding, modulation, demodulation, or other modem operations are performed in accordance with a signal protocol or communication standard.

These signal protocols or standards may include cellular protocols or other networking standards, such as a 3rd Generation Partnership Project (3GPP) protocol, Global System for Mobiles (GSM), Code Division Multiple Access (CDMA), Long Term Evolution (LTE) protocol, Institute of Electrical and Electronics Engineers (IEEE) 802.11 standard, IEEE 802.16 standard and the like.

System-on-chip 604 may be integrated with a microprocessor, storage media, I/O logic, data interfaces, logic gates, a transmitter, a receiver, circuitry, firmware, software, or combinations thereof to provide communicative or processing functionalities. System-on-chip 604 may include a data bus (e.g., cross bar or interconnect fabric) enabling communication between the various components of the system-on-chip. In some aspects, components of system-on-chip 604 may interact via the data bus to implement aspects of region-based cache management.

In this particular example, system-on-chip 604 includes processor cores 608, system memory 610, and cache memory 612. System memory 610 or cache memory 612 may include any suitable type of memory, such as volatile memory (e.g., DRAM or SRAM), non-volatile memory (e.g., Flash), and the like. System memory 610 and cache memory 612 are implemented as a storage medium, and thus do not include transitory propagating signals or carrier waves. System memory 610 can store data and processor-executable instructions of system-on-chip 604, such as operating system 614 and other applications.

Processor cores 608 execute operating system 614 and other applications from system memory 610 to implement functions of system-on-chip 604, such as frequency translation, encoding, decoding, modulation, and/or demodulation. Data associated with these functions can be stored to cache memory 612 for future access. In some aspects, cache memory 612 is configured as an L1 cache memory or L2 cache memory in which aspects of region-based cache management can be implemented. System-on-chip 604 may also include I/O logic 616, which can be configured to provide a variety of I/O ports or data interfaces for inter-chip or off-chip communication.

System-on-chip 604 also includes cache manager 108, analog RF circuitry 110, and baseband circuitry 112, which may be embodied separately or combined with other components described herein. For example, cache manager 108 may further include or have access to configuration registers 208, scheduler 226, or cache policies 228 as described with reference to FIG. 2. Cache manager 108 can be implemented to allocate regions of cache memory 612 for respective functions of system-on-chip 604. In some aspects, cache manager 108 applies cache policies or schemes to the regions of cache memory 612 based on a type of data that is to be written to the region. Cache manager 108, either independently or in combination with other components (e.g., scheduler 226 and cache policies 228), can be implemented as processor-executable instructions stored in system memory 610 and executed by processor cores 608 to implement operations described herein.

Cache manager 108 may also be integrated with other components of system-on-chip 604, such as cache memory 612, a memory controller of system-on-chip 604, or any other signal processing, modulating/demodulating, or conditioning section within system-on-chip 604. Cache manager 108 and other components of system-on-chip 604 may be implemented as hardware, fixed-logic circuitry, firmware, or a combination thereof that is implemented in association with I/O logic 616 or other signal processing circuitry of system-on-chip 604.

Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. A method for managing a cache memory of a processor, the method comprising:
determining a configuration for a region of the cache memory of the processor;
allocating, based on the determined configuration, an address range of the cache memory to define the region within the cache memory; and
applying, based on the determined configuration, a cache policy to the allocated address range to control caching of information written to the region of cache memory.

2. The method as recited in claim 1, wherein the determined configuration includes a size of the region of cache memory, the cache policy for the region of cache memory, or a location of the region within the cache memory.

3. The method as recited in claim 1, wherein the cache policy includes one of a write-through cache policy, a write-back cache policy, or read-only cache policy.

4. The method as recited in claim 1, wherein the configuration is determined based on a particular function that will access the cache memory or characteristics of the information to be written to the cache memory.

5. The method as recited in claim 4, wherein the characteristics of the information comprise a type of usage, locality of the information, or access bandwidth.

6. The method as recited in claim 4, wherein the characteristics of the information correspond to a particular function that will access the information of the region of cache memory.

7. The method as recited in claim 6, further comprising monitoring operation of the function for completion and, responsive to the completion of the function's operation, releasing the region of cache memory.

8. The method as recited in claim 1, wherein the cache memory is level one (L1) or level two (L2) cache memory.

9. The method as recited in claim 1, wherein the cache memory is shared cache memory accessed by at least two signal processing functions implemented by the processor.

10. The method as recited in claim 1, wherein the address range of the cache memory is allocated by issuing a pre-fetch instruction for the information to be written to the region of cache memory.

11. The method as recited in claim 1, wherein the cache policy is applied to the allocated address range by issuing a pre-fetch instruction for the information to be written to the region of cache memory.

12. An apparatus for processing signals, the apparatus comprising:
a processor configured to implement functions that facilitate the processing of the signals;
a cache memory associated with the processor and configured to store information associated with the processing of the signals; and
a cache manager configured to:
determine a configuration for a region of the cache memory;
allocate, based on the determined configuration, an address range of the cache memory to define the region within the cache memory; and
apply, based on the determined configuration, a cache policy to the allocated address range to control caching of the information associated with the processing of the signals.

13. The apparatus as recited in claim 12, wherein the multiple functions comprise one of a log-likelihood ratio (LLR) function, fast-Fourier transform (FFT) function, discrete Fourier transform (DFT) function, in-phase and quadrature-phase (IQ) function, hybrid-automatic repeat request (HARQ) function, modulation function, or demodulation function.

14. The apparatus as recited in claim 12, wherein the cache manager is further configured to determine the configuration for the region based on an information access pattern associated with the function that is to be implemented by the processor.

15. The apparatus as recited in claim 12, wherein the apparatus further comprises one or more registers for configuring the cache memory and the cache manager allocates the address range or applies the cache policy by accessing the one or more registers.

16. The apparatus as recited in claim 12, wherein the cache manager allocates the region of cache memory or applies the cache policy by issuing a pre-fetch instruction that includes bits configured to set the address range or specify the cache policy applied to the region of cache memory.

17. The apparatus as recited in claim 12, wherein the apparatus comprises another processor configured to implement a protocol stack, and wherein the cache manager is implemented via a layer of the protocol stack.

18. The apparatus as recited in claim 12, wherein the cache memory is a single level one (L1) cache memory or a shared L1 cache memory, and the region of the cache memory comprises less than an entire address space of the single L1 cache memory or shared cache memory.

19. The apparatus as recited in claim 12, wherein the apparatus is configured in whole or part as a modem that enables wired or wireless communication.

20. An apparatus for processing signals, the apparatus comprising:
a processor configured to implement multiple functions that facilitate the processing of the signals;
a cache memory associated with the processor and configured to store information associated with the processing of the signals;
means for determining, based on which of the multiple functions is to be implemented by the processor, a configuration for a region of the cache memory;
means for allocating, based on the determined configuration, an address range of the cache memory to define the region within the cache memory; and
means for applying, based on the determined configuration, a cache policy to the allocated address range to control caching of the information associated with the processing of the signal.
